(19) United States
(12) Patent Application Publication
(10) Pub. No.: US 2014/0337955 A1
(43) Pub. Date: Nov. 13, 2014

(54) AUTHENTICATION AND AUTHORIZATION WITH A BUNDLED TOKEN

(71) Applicant: Microsoft Corporation, Redmond, WA (US)

(72) Inventors: Meir Mendelovich, Kfar-Saba (IL); Sharon Laivand, Herzliah (IL); Michael Binshtock, Tel Aviv (IL); Avraham Carmon, Herzeliya (IL); Jairo A. Cadena Briceno, Lake Stevens, WA (US); Mark Waitser, Herzeliya (IL); Tzvi Keisar, Haifa (IL)

(21) Appl. No.: 13/890,374

(22) Filed: May 9, 2013

(51) Int. Cl. H04L 29/06

(52) U.S. Cl. CPC H04L 63/08
USPC 726/9

(57) ABSTRACT

Authentication and authorization can be performed with a bundled token, which encapsulates two or more security tokens in a single security token. The bundled token can be supplied in response to a request for a token from a token service, for example. Subsequently, the bundled token can be sent in conjunction with a request for resource access, wherein more than one token is required to access the resource.

### BACKGROUND

Authentication and authorization can be employed to enable access control. Authentication is a process of confirming the identify of a client (e.g., human being, software application, computing device . . . ) attempting to access a secure resource, for instance. Subsequently, a determination can be made as to whether the authenticated client is authorized to access the resource. An authentication service is conventionally employed separate from the client and secure resource. The authentication service authenticates clients and issues security tokens accepted by resources as proof of authentication.

By way of example, consider a client that issues a request to access a secure resource such as a software application. Rather than authenticating the client directly, the software application can redirect the user to an authentication service. The client submits a set of credentials to the authentication service comprising something unique to the client, such as a user name and password. If the credentials match those known to be associated with a client identity, the client is authenticated and a security token is issued that indicates the identity of the client has been confirmed by the authentication service. The client can then resubmit a request for access to the software application with the security token. Upon receipt, the software application seeks to validate the token by among other things verifying that the token originated from a trusted authentication service and is valid at the current time. If the token is validated, authorization decisions can be based on the identity of the client.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to authentication and authorization with a bundled token. In response to a request for authentication from a client, a bundled token can be returned that encapsulates two or more security tokens within a single bundled token. A request message for resource access can be formulated and sent that includes the bundled token. One or more entities, such as a proxy, in the route of the request message between the client and the resource can open the bundled token, locate a specific security token, and attempt to validate the token. If the token is valid and the corresponding authenticated client is authorized, the message can be forwarded with a modified bundled token that does not include the specific token. Further, if the bundled token includes solely a single token, the single token can be extracted and sent with the message rather than the bundled token.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a representative authentication and authorization system.

FIG. 2 is a block diagram of a representative token service component.

FIG. 3 is a block diagram of depicting a representative bundled token.

FIG. 4 is a block diagram of a representative proxy component.

FIG. 5 is a flow chart diagram of a method of authentication.

FIG. 6 is a flow chart diagram of a method of requesting access to a resource by a client.

FIG. 7 is a flow chart diagram of a method of authentication and authorization with a bundled token.

FIG. 8 is a schematic block diagram illustrating a suitable operating environment for aspects of the subject disclosure.

### DETAILED DESCRIPTION

Access to a resource can involve use of security tokens. More specifically, upon verification of client's credentials a security token can be issued. Subsequently, the security token can be included with a request for resource access. If the security token is valid and the corresponding client is authorized, the client may access to the resource. There are cases, however, in which additional security tokens are required to access a resource. For example, multiple layers of security may exist between a client and a resource that each requires its own token. Conventional client applications and protocols (e.g., OAuth), however, were not designed to support multiple security tokens but rather expect a single specific token.

Details below generally pertain to a bundled token that encapsulates multiple security tokens in a single token. After at least verifying credentials provided in conjunction with an authentication process for resource access, a bundled token can be returned. The bundled token, in one instance, can comprise one or more access security tokens as well as a resource security token encapsulated within a single security token. The bundled token can be included with a request message for resource access. One or more entities in the route of the message that require a security token can open the bundled token, locate a specific token, validate the token, and if the token is valid and a corresponding user is authorized, the message is forwarded with a modified bundled token that does not include the specific token. If a single token remains in the bundled token, the bundled token can be replaced with the single remaining token. As a result, selective resource access is enabled in a single transaction in such a way that conventional single-token applications and protocols can be employed without modification.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

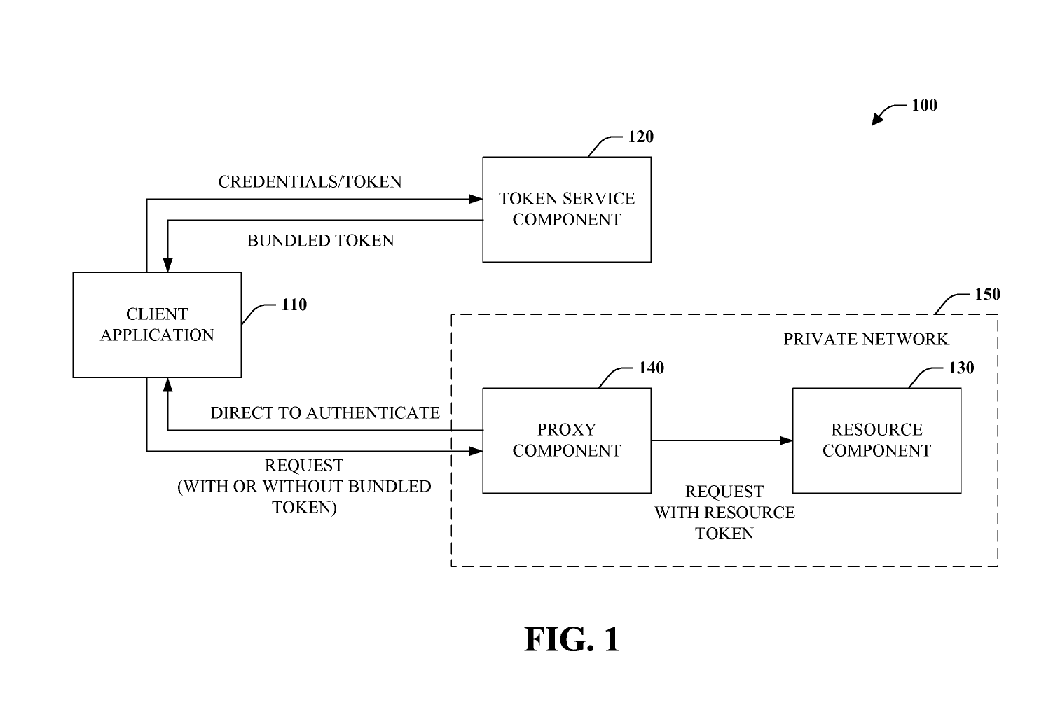

Referring initially to FIG. 1, an exemplary authentication and authorization system 100 is illustrated. The system 100 includes client application 110. Also included in the system 100 is token service component 120, which is configured to at least authenticate users and issue security tokens. Resource component 130 corresponds to a computational resource that may be accessible by the client application 110. The system 100 further includes proxy component 140 that resides between the client application 110 and the resource component 130.

The client application 110 can correspond to any software application executable by a computing device. In embodiment, however, the client application 110 can correspond to an application designed to run on a tablet and acquired from an online application store (e.g., Windows Store Application). Nevertheless, the client application 110 can be executable by any computing device, such as but not limited to a desktop computer, laptop computer, tablet or mobile phone. As will be discussed further below, the computing device need not be a managed computing device but rather can also correspond to an unmanaged computing device.

The client application 110 is one embodiment. However, the subject application is not limited thereto. The term “client” is used herein to identify a system participant that seeks to access a resource and provides credentials for authentication. In one instance, the participant can be a software application, such as one designed to execute on a tablet or particular operating system. In other instances, the participant can correspond to human being or a computing device.

The token service component 120 is configured to authenticate a client, such as the client application 110, and generate security tokens. More specifically, a set of credentials comprising something unique to a client can be provided to the authentication component 120. For example, credentials can include, but are not limited to, one or more of a secret the client knows like a user name and password, something a client has such as a smart card or hardware token, or something about the client such as an identifier or biometric feature. If the set of one or more credentials provided matches a set of one or more credentials that correspond to the client's identity (who/what the client claims to be), the client is authenticated. In other words, the token service component 120 confirms the identity of the client by verifying the validity of provided credentials. The token service component 120 can also be configured to verify that the client is eligible to receive a token for a resource provider, or in other words, authorize the client. For example, the client might be required to tell the authentication component that he/she wants to reach network 150 or even resource component 130 in order to receive a token, and the token service component 120 can verify that the client is eligible to acquire access to those resources. Subsequently, a security token is issued that represents a collection of claims or declarations by an entity. For example, the claim can correspond to the identity of the user indicating that user was authenticated by the token service component 120. In addition, a claim can provide an indication that the client is authorized to access particular resources. Furthermore, the security token can be a signed security token meaning the security token is cryptographically signed by a specific authority, for instance to enable subsequent verification of the source of the token. In addition to issuing conventional security tokens, the token service component 120 is also configured to formulate and provide a bundled token. A bundled token encapsulates two or more security tokens in a single security token. Stated differently, the bundled token is a single token container for multiple tokens.

In accordance with one non-limiting embodiment, the token service component 120 can be implemented as a security token service (STS) or the like. An STS can be implemented as a web service that issues and manages security tokens. More specifically, an STS can make statements or claims by way of security tokens based on evidence that it can directly verify or from security tokens from trusted authorities.

The resource component 130 can correspond to any one of a number of different computing resources such as, but not limited to, a database, software application, or various computing hardware. Moreover, the resource component 130 can be a secure resource meaning access to the resource is controlled or limited. For example, access can be controlled as a function of client identity, role, or group, among other things. Accordingly, a security token including a collection of one or more claims can be employed to facilitate making decisions regarding authorization to access the resource component 130.

The proxy component 140 can provide an addition layer of security with respect to access of the resource component 130. The proxy component 140 can also employ a security token to aid a decision regarding authorization to attempt to directly access, or otherwise interact with, the resource component 130. In accordance with one embodiment, the proxy component 140 can be a proxy server that acts as an intermediary for requests between a client and a resource. Furthermore, the proxy component 140 and the resource component 130 in accordance with one embodiment can reside within a private network 150. Here, the proxy component 140 can be embodied as an edge proxy that separates the private network 150 from a public network (e.g., Internet) and protects the private network 150 by limiting access to the private network 150 to authorized clients. The proxy component 140 can thus be configured to enable selective access to the private network 150 utilizing a network-access security token, for example, which can potentially limit the denial-of-service attacks with respect to the resource component 130, among other things. Additionally, system 100 shows a single proxy component 140. However, it is to be appreciated that any number of proxy components can be inserted between the resource component 130 and potential users thereof, for instance to provide additional levels of security. Furthermore, the proxy component 140 is just one example of a type of entity that can between a client and a resource that requires an additional token.

Various protocols can be involved with respect to the system 100. For example, OAuth, which provides a protocol for clients to access secure resources, can be employed since a single security token is utilized. Furthermore, WS-Federation, or the like, which deals with linking a client's identity across distinct identity management systems, can be extended to support the functionality disclosed herein.

What follows is a description of an exemplary interaction between components of the authentication and authorization system 100 to at least aid in understanding the functionality of particular components and a communication protocol employed. Of course, this is only one of many different ways in which the components can interact. Accordingly, the below description is not meant to implicitly limit the scope of the subject disclosure.

Starting with the client application 110, assume it is desirous for the client application 110 to access or otherwise interact with the resource component 130. In furtherance thereof, a request can be issued from the client application 110 to the resource component 130. However, here, the request is acquired first by the proxy component 140 acting as an intermediary between the client application 110 and the resource component 130. The proxy component 140 will check to determine if the request includes a bundled token. If not, the client application 110 can be directed a location where authentication can be performed, namely at token service component 120 in this case. In one instance, for example, an HTTP (HyperText Transfer Protocol) error message can be returned by the proxy component 140 with additional information identifying or otherwise signally the need to authenticate and an address (e.g., Uniform Resource Identifier (URI)) where authentication can be performed.

Next, the client application 110 can interact with the token service component 120 to acquire a bundled token comprising an access security token for the proxy component 140 and a resource security token for the resource component 130. More particularly, the client application 110 can request authentication, wherein a request message includes one or more credentials, among other information, such as, but not limited to, a username and password. If the credentials and other information provided match that stored by the authentication component 120, the user is authenticated and a security token can be provided. Further, a determination can be made by the token service 120 that the client is authorized to receive a token before the token is provided. Moreover, the security token issued can be a bundled token that embeds an access security token and a resource security token into a single bundled token.

Furthermore, the token service component 120 can also be configured to output an additional token, namely an authentication, or context, token that can be utilized with respect to subsequent interactions with the authentication component 120 without having to provide credentials again. This authentication token can be saved on the client for use in subsequent authentication requests. Among other things, the authentication token enables single-sign-on functionality where a user provides credentials once and subsequent is able to access resources without re-authenticating.

The client application 110 can subsequently send a request to access the resource component 130 with the acquired bundled token. For example, the request may be formulated as follows: “GET/POST(url=Resource, Authorization=BundledToken(ResourceToken+AccessToken).” In response, the proxy component 140 can extract the access token from the bundled token and verify, among other things that the token was issued by a trusted source and is currently valid. A determination can then be made as to whether the client requesting access is authorized. In accordance with one embodiment, the proxy component 140 can perform the authorization. In an alternative embodiment, the authorization can performed by the token service component 120 leaving the proxy 140 with the task of simply validating the token itself and the source of the token. If the client is authorized, the proxy component 140 can forward a modified request to the resource component 130 where the bundled token is replaced by the resource token. For example, the request may be GET/POST(url=Resource, Authorization=ResourceToken).

Upon receipt of the request, the resource component 130 can verify that the resource security token was issued from a trusted source and is currently valid. In other words, the resource component 130 can seek to validate the token. If token validation is successful, a decision is made concerning whether the user is authorized to access the resource component. If the user is authorized, access is granted. If the user is not authorized, access is denied. In this embodiment, the resource component 130 performs authentication. In an alternate embodiment, as with the proxy component 140, authorization can performed by the token service component 120 leaving the resource component 140 with the task of simply validating the token.

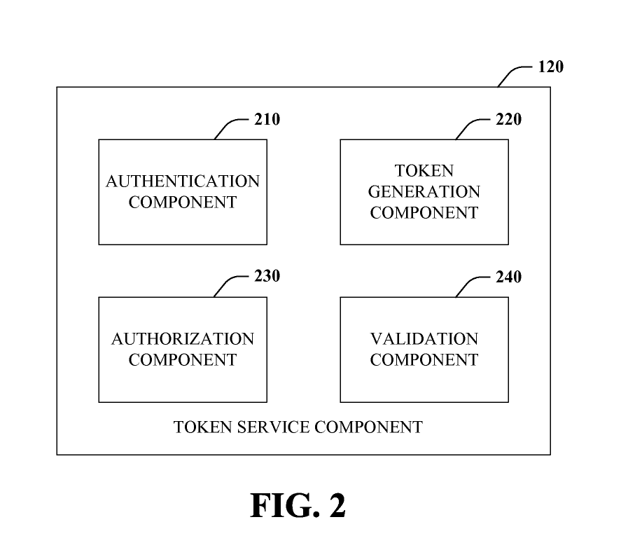

Turning attention to FIG. 2, a representative token service component 120 is depicted. The token service component 120 includes authentication component 210, token generation component 220, authorization component 230, and validation component 240.

The authentication component 210 is configured to verify the identity of a client (e.g., human being, software application . . . ) based on a set of one or more credentials provided. Stated differently, the authentication component 210 can attempt to confirm the identity of the requesting client as a function of direct evidence, namely the set of credentials. If the identity of a client is verified, or confirmed, the user is deemed authentic or, in other words, the user has been authenticated.

The token generation component 220 can be invoked after the verification component 210 verifies the identity of a requesting client. In response, the token generation component 220 can generate a security token that includes one more claims about the client, such as the identity of the client. Furthermore, the security token can be cryptographically signed to by a certification authority. In this manner, it is possible to confirm the entity that issued the security token. Moreover, the token generation component 220 is configured to generate and issue bundled tokens comprising two or more security tokens encapsulated in a single security token. For example, such tokens can be encoded as BundledToken=(FirstToken+SecondToken . . . ) or BundledToken=(FirstToken, SecondToken, . . . ).

The tokens service component 120, in one embodiment, can also perform authorization prior to issuing a token. The authorization component 230 is configured to perform this functionality. More specifically, the authorization component 230 can verify that an authenticated client is authorized to access a particular resource or set of provided resources. Accordingly, in addition to providing user credentials, a particular resource or set of resources can be identified by a client in a request message that the client desires to access. The authorization component can compare the identity of the client and requested resource to those resources the client has been authorized to access. If the user has been is authorized, the token generation component 220 can issue the token. Otherwise, client can be notified that he/she is not authorized to access requested resource.

The token generation component 220 can also be configured to issue a security token associated with authentication, in other words, an authentication, or context, security token. Once a user's credentials are verified, the token generation component can issue an authentication token. Each additional time security tokens are desired instead of providing credentials the authentication security token can be provided. The validation component 240 can be configured to validate the authentication token by confirming the token was issued by the token service component 120, the token was not tampered with after it was issued, and it is currently valid or unexpired. If the authentication security token is validated, a session can be established with the token service component 120 without providing credentials. If the authentication security token is not validated, the user credentials can be submitted with a request for authentication.

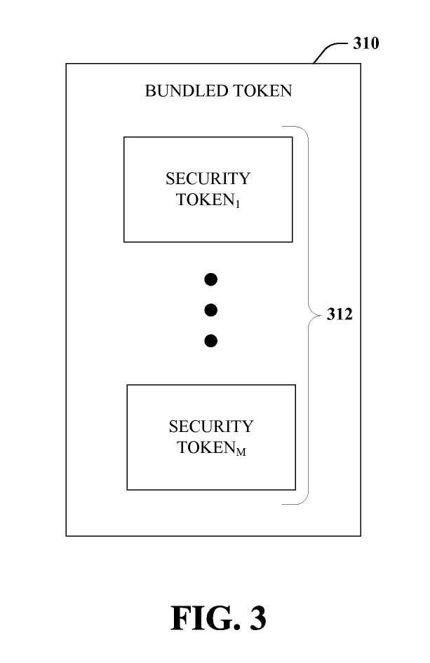

FIG. 3 is a block diagram illustrating a representative bundled token 310. The bundled token 310 is a single token container for a plurality of security tokens 312 (SECURITY TOKEN₁−SECURITY TOKEN_{M}, where M is an integer greater than or equal to two). Stated differently, the bundled token encapsulates or embeds two or more security tokens in a single security token. In one embodiment, one of the security tokens 312 can correspond to a resource security token for a computational resource and one or more security tokens can correspond to assess security tokens for entities, such as proxies, positioned between the computational resource and the client.

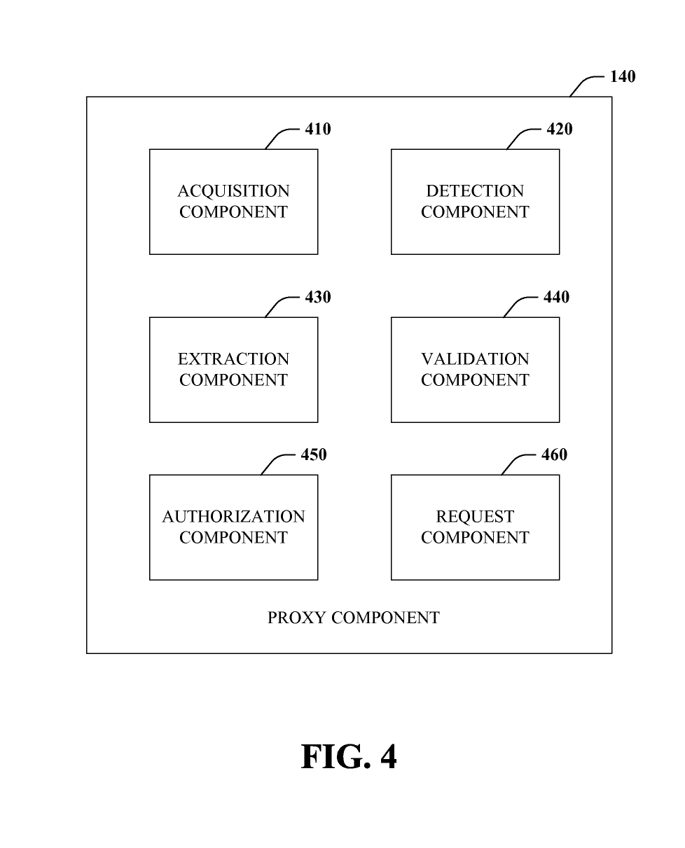

FIG. 4 depicts a representative proxy component 140. The proxy component 140 includes acquisition component, 410, detection component 420, extraction component 430, validation component 440, authorization component 450, and request component 460.

The acquisition component 410 is configured to receive, retrieve, or otherwise obtain or acquire a request for a resource access. In other words, the proxy component 140 is positioned between a requesting entity and a resource, and the acquisition component 410 can intercept the request targeting the resource.

The detection component 420 is configured to analyze the request and determine whether the request includes a bundled token comprising an access security token for the proxy component. If the request does not include such a bundled token, the detection component 420 can generate an error message or the like that includes the address of a location for authentication. Stated differently, the detection component 420 signals a requesting client that authentication should be performed and provides identifies an address of a location for authentication. Alternatively, if the detection component 420 identifies a bundled token, extraction component 430 is invoked.

The extraction component 430 is configured to read the bundled token, identify the specific access security token for the proxy component 140 amongst two or more security tokens, and acquire the access security token. In one instance, the extraction component 430 can strip or remove the access security token from the bundled token.

The validation component 440 is configured to validate the access security token. Validation can comprise confirming the source of the token is trusted, the token has not been tampered with since issuance, and the token is valid for the current time and has not expired, among other things. If requisite conditions are confirmed regarding the access security token, validation is successful. Otherwise, validation fails. If validation is successful, authorization component 450 can be invoked for execution. If validation fails, an error message can be returned that notes the failure and optionally identifies a location for re-authenticating.

The authorization component 450 is configured to determine whether access is authorized. In accordance with one embodiment, a list of clients that are authorized can be maintained and the identity of the requesting client compared with the list of authorized clients. If the client is on the list, client access is authorized. Otherwise, access is unauthorized. If the authorization component 450 determines the client is authorized, execution of the request component 460 can be initiated. Alternatively, an error message can be provided that indicates that access is denied because the client is not authorized, or the like.

The request component 460 is configured to formulate a subsequent request. For instance, an acquired request can be modified to include a bundled token exclusive of the specific access token associated with the proxy component. This request can then be forwarded to the next entity in the communication route. In one instance, that could be another proxy or the like. In another instance, that could be the resource targeted by the request. When the bundled token includes solely a single token, the request component 460 can be configured to extract the single token and formulated a request including the single token as opposed to the bundled token comprising a single token.

Where the resource component 130 and one or more proxy components 140 are connected within private network 150 as shown in FIG. 1, aspects of this subject disclosure provide remote network access functionality with benefits over conventional solutions such as virtual private networks (VPNs) and direct access. In particular, traditional VPNs allow access to all resources of a private network, while aspects of the subject disclosure enable selective access. Direct access is a technology that allows seamless connectivity to a private network from any remote location without having to establish a virtual private network connection. However, direct access works with managed clients. That is, particular software is installed on the client to enable an administrator manage the client by way of monitoring and deployment of updates, for example. The subject disclosure can operate with respect to managed clients but also unmanaged clients. As a result, employees of a company could utilize personal computing devices to select access resources on a private company network, for example.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

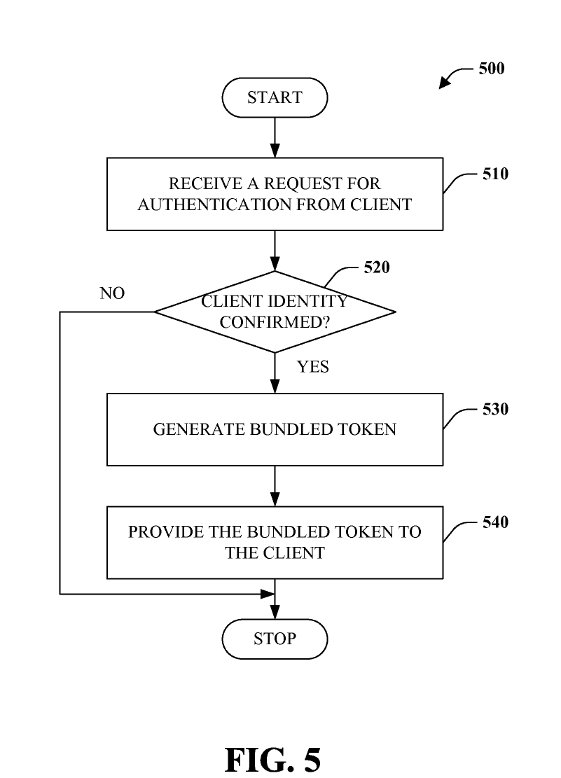

In view of the exemplary systems described above, methodologies that may be implemented in accordance with the disclosed subject matter will be better appreciated with reference to the flow charts of FIGS. 5-7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG.5, a method of authentication 500 is illustrated. At reference numeral 510, request for authentication is received, retrieved, or otherwise obtained or acquired from a client (e.g., user, software application, computing device). Additional authentication information can be provided as part of the request for authentication. In one instance, the authentication information can also include a set of credentials such as a user name and password and/or data from a smart card, among other things. In another instance, the authentication information can include an authentication token provided in conjunction with a prior authentication session. At numeral 520, a determination is made as to whether the client's identity can be confirmed. This process can be accomplished based one provided credentials or an authentication token. If client identity cannot be confirmed (“NO”), the method terminates, optionally sending an error message prior to termination (not shown). Alternatively, if client identity can be confirmed (“YES”), the method continues at numeral 530, where a bundled token is generated that encapsulates two or more security tokens in a single token. For example, one token can be a resource token associated with accessing a targeted resource and one or more tokens can be access tokens associated with one or more proxies. At reference numeral 540, the generated bundled token can be provided, or otherwise made available, to the client, in response to the request for authentication.

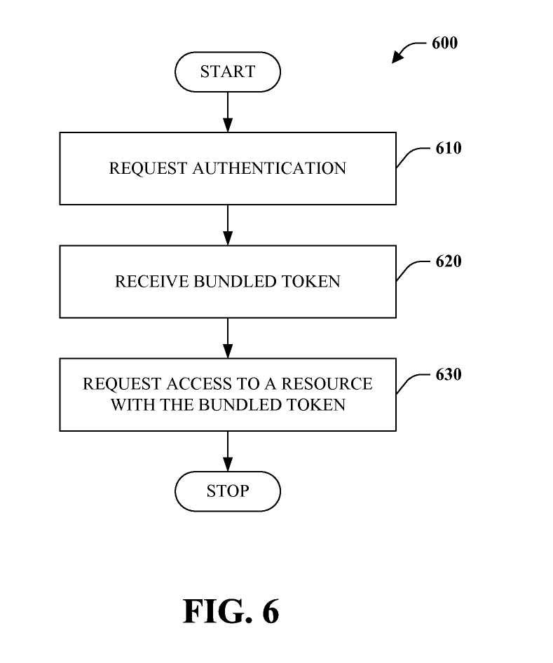

FIG. 6 is a flow chart diagram of a method 600 of requesting access to a resource from a client. At reference numeral 610, a request for authentication with respect to a particular resource together with additional authentication information can be sent to an authentication system or service. In accordance with one embodiment, the request can also solicit permission to access a particular resource, or, in other words, authorization. In accordance with one embodiment, the request can be provided to a security token service (STS), for example in conjunction with a modified WS-Federation protocol dealing with linking a client's identity across distinct identity management systems and OAuth that provides a protocol for clients to access secure resources using a single token. A bundled token encapsulating two or more security tokens associated with accessing a resource is received, retrieved, or otherwise obtained or acquired at 620 in response to the request for authentication. At numeral 630, access to a targeted resource is requested with the bundled token. In other words, a request message including the bundled token is formulated and transmission of the request message initiated with respect to the target resource.

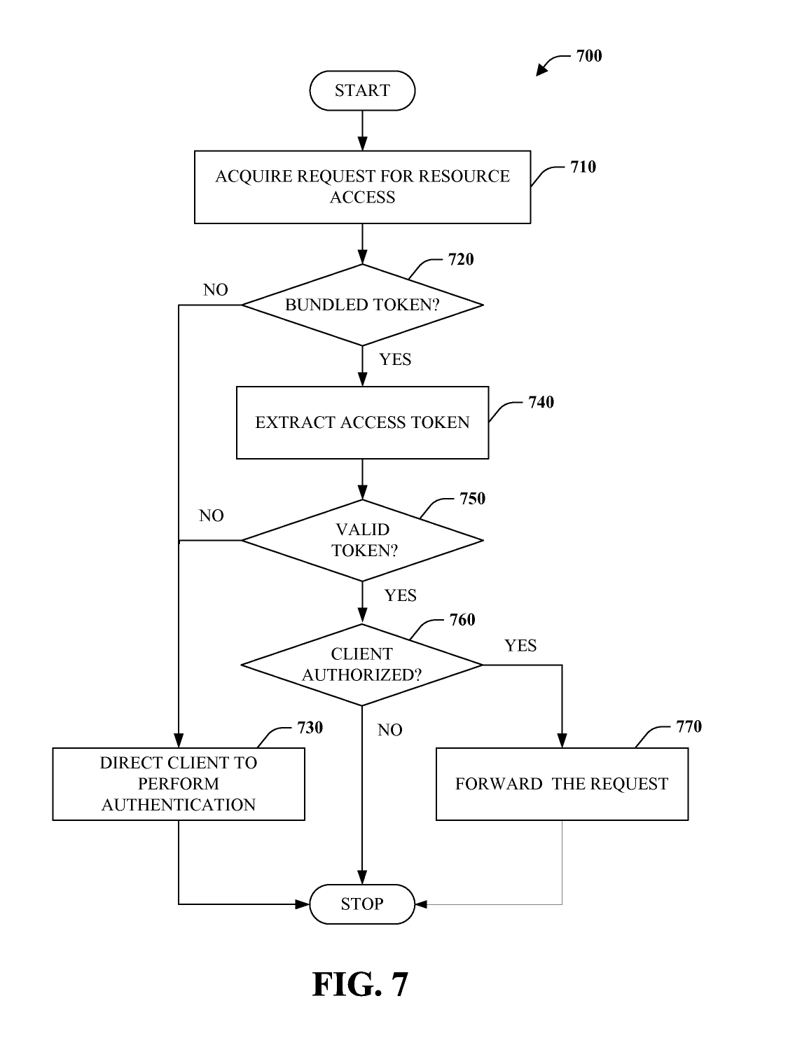

FIG. 7 depicts a method of authentication and authorization with a bundled token. At reference numeral 710, a request for resource access is received, retrieved or otherwise obtained or acquired. At numeral 720, a determination is made as to whether a bundled token is included with the request. If a bundled token is not present (“NO”), the method proceeds to numeral 730, where a client is directed to perform authorization and optionally provided with the location of a authentication system or service. If a bundled token is present with the request (“YES”), the method continues at numeral 740, where an access token is extracted from the bundled token. At reference numeral 750, a determination is made concerning whether the access security token is valid. Such a determination can involve one or more of confirming the token was provided by a trusted source, the token was not tampered with after issuance, or the token has not expired, among other things. If token is invalid (“NO”), the method proceeds to 730 where a client can be directed to re-authenticate or receive an error message in addition or as an alternative to directing the client to re-authenticate. If the token is valid (“YES”), the method continues to numeral 760, where a determination is made as to whether the client is authorized. Access can be limited to a pre-determined set of authorized clients. If the client is one of the set of authorized clients, the client is authorized. Otherwise, the client is not authorized. If at 760, the client not authorized (“NO”), the method can terminated optionally with a message indicating that the client authorization failed (not shown). If the client is authorized (“YES”), the method continues at 770, where the request is forwarded to the next entity in route to the resource. More specifically, the request can be forwarded with a bundled token without the extracted access token. Furthermore, if the bundled token includes solely a single token, the request is forwarded with the single token rather than the bundled token.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

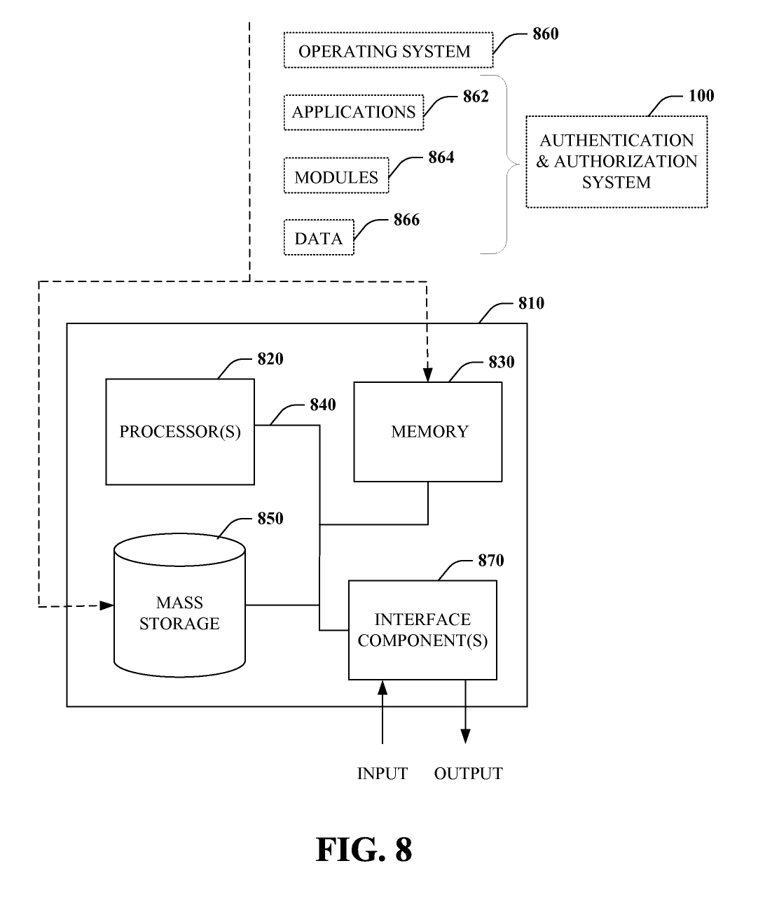

In order to provide a context for the claimed subject matter, FIG. 8 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 8, illustrated is an example general-purpose computer 810 or computing device (e.g., desktop, laptop, tablet, server, hand-held, programmable consumer or industrial electronics, set-top box, game system, compute node . . . ). The computer 810 includes one or more processor(s) 820, memory 830, system bus 840, mass storage 850, and one or more interface components 870. The system bus 840 communicatively couples at least the above system components. However, it is to be appreciated that in its simplest form the computer 810 can include one or more processors 820 coupled to memory 830 that execute various computer executable actions, instructions, and or components stored in memory 830.

The processor(s) 820 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 820 may also be implemented as a combination of computing devices, for example a combination of a DSP and a microprocessor, a plurality of microprocessors, multi-core processors, one or more microprocessors in conjunction with a DSP core, or any other such configuration.

The computer 810 can include or otherwise interact with a variety of computer-readable media to facilitate control of the computer 810 to implement one or more aspects of the claimed subject matter. The computer-readable media can be any available media that can be accessed by the computer 810 and includes volatile and nonvolatile media, and removable and non-removable media. Computer-readable media can comprise computer storage media and communication media.

Computer storage media includes volatile and nonvolatile, removable and non-removable media implemented in any method or technology for storage of information such as computer-readable instructions, data structures, program modules, or other data. Computer storage media includes memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that can be used to store the desired information and accessed by the computer 810. Furthermore, computer storage media excludes modulated data signals.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 830 and mass storage 850 are examples of computer-readable storage media. Depending on the exact configuration and type of computing device, memory 830 may be volatile (e.g., RAM), non-volatile (e.g., ROM, flash memory . . . ) or some combination of the two. By way of example, the basic input/output system (BIOS), including basic routines to transfer information between elements within the computer 810, such as during start-up, can be stored in nonvolatile memory, while volatile memory can act as external cache memory to facilitate processing by the processor(s) 820, among other things.

Mass storage 850 includes removable/non-removable, volatile/non-volatile computer storage media for storage of large amounts of data relative to the memory 830. For example, mass storage 850 includes, but is not limited to, one or more devices such as a magnetic or optical disk drive, floppy disk drive, flash memory, solid-state drive, or memory stick.

Memory 830 and mass storage 850 can include, or have stored therein, operating system 860, one or more applications 862, one or more program modules 864, and data 866. The operating system 860 acts to control and allocate resources of the computer 810. Applications 862 include one or both of system and application software and can exploit management of resources by the operating system 860 through program modules 864 and data 866 stored in memory 830 and/or mass storage 850 to perform one or more actions. Accordingly, applications 862 can turn a general-purpose computer 810 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the authentication and authorization system 100, or portions thereof, can be, or form part, of an application 862, and include one or more modules 864 and data 866 stored in memory and/or mass storage 850 whose functionality can be realized when executed by one or more processor(s) 820.

In accordance with one particular embodiment, the processor(s) 820 can correspond to a system on a chip (SOC) or like architecture including, or in other words integrating, both hardware and software on a single integrated circuit substrate. Here, the processor(s) 820 can include one or more processors as well as memory at least similar to processor(s) 820 and memory 830, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the authentication and authorization system 100 and/or associated functionality can be embedded within hardware in a SOC architecture.

The computer 810 also includes one or more interface components 870 that are communicatively coupled to the system bus 840 and facilitate interaction with the computer 810. By way of example, the interface component 870 can be a port (e.g., serial, parallel, PCMCIA, USB, FireWire . . . ) or an interface card (e.g., sound, video . . . ) or the like. In one example implementation, the interface component 870 can be embodied as a user input/output interface to enable a user to enter commands and information into the computer 810, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 870 can be embodied as an output peripheral interface to supply output to displays (e.g., CRT, LCD, LED, plasma . . . ), speakers, printers, and/or other computers, among other things. Still further yet, the interface component 870 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A computer-implemented method, comprising:
receiving a request to access a resource; and
determining whether the request includes a bundled token encapsulating two or more security tokens in a single security token.

2. The method of claim 1 further comprises responding to the request with a signal identifying a location for authentication, if the request does not include the bundled token.

3. The method of claim 1 further comprises extracting a first security token from the bundled token if the request includes the bundled token.

4. The method of claim 3 further comprises performing token validation on the first security token.

5. The method of claim 4 further comprises responding to the request with a signal identifying a location for authentication, if the first security token is invalid.

6. The method of claim 4 further comprises determining whether to allow access to a network including the resource based on the first security token, if the first security token is valid.

7. The method of claim 6 further comprises formulating a request for access to the resource with a second security token of the bundled token.

8. The method of claim 3 further comprises formulating a request for access to the resource with a second security token of the bundled token.

9. The method of claim 1 further comprises receiving the request to access a private network resource from outside the private network.

10. The method of claim 9 further comprising receiving the request from an unmanaged computing device.

11. A system, comprising:
a processor coupled to a memory, the processor configured to execute the following computer-executable components stored in the memory:
a first component configured to control access to a private network resource as a function of a bundled token that comprises a network-access security token and a resource security token embedded within a single security token.

12. The system of claim 11 further comprises a second component configured to extract the network-access security token from the bundled token.

13. The system of claim 12 further comprises a second component configured to validate the network-access security token.

14. The system of claim 12 further comprises a second component configured to determine if a client is authorized to access the private network based on the network-access security token.

15. The system of claim 11 further comprises a second component configured formulate a request to access the access the private network resource with solely the resource security token.

16. The system of claim 11, the first component is configured to control access from an unmanaged computing device.

17. A computer-readable storage medium having instructions stored thereon that enable at least one processor to perform a method upon execution of the instructions, the method comprising:
receiving a request for a security token; and
generating a bundled token comprising two or more security tokens embedded in a single security token in response to the request.

18. The method of claim 17 further comprises returning the bundled token in response to the request.

19. The method of claim 17 further comprises receiving client credentials with the request.

20. The method of claim 17 further comprises receiving a previously provided authentication token with the request.
